(19) United States
(12) Patent Application Publication
(10) Pub. No.: US 2015/0174624 A1
(43) Pub. Date: Jun. 25, 2015

(54) APPARATUS AND METHOD FOR CLEANING A ROUNDED TANK

(71) Applicant: Anthony William Cunningham, Springfield (AU)

(72) Inventor: Anthony William Cunningham, Springfield (AU)

(21) Appl. No.: 14/133,710

(22) Filed: Dec. 19, 2013

(51) Int. Cl. B08B 9/087

(52) U.S. Cl. CPC B08B 9/087

(57) ABSTRACT

An apparatus for cleaning a rounded tank such as the tank of a gasoline tanker has a pivoting coupler between its handle and the base its cleaning head. In this embodiment the base of the head is formed with lugs which receive a tongue. The tongue is formed on an end of the pivoting coupler. A pin traverses corresponding holes in the lugs and pivoting coupler in order to allow the pivoting coupler to pivot relative to the head. Further embodiments include a water supply tank mounted to the handle and a pump arranged to urge water from the tank through a conduit out through the head of the cleaning apparatus.

### TECHNICAL FIELD

The present invention relates to an apparatus and method for cleaning rounded tanks such as the tank of a gasoline truck.

### BACKGROUND

The discussion of any prior art documents, techniques, methods or apparatus is not to be taken to constitute any admission or evidence that such prior art forms, or ever formed, part of the common general knowledge.

Oil tankers, tank trucks, gas trucks and tank lorries are a familiar sight on the road with cylindrical tanks mounted on the chassis of a truck. Such vehicles are commonly used to transport fluids such as, oil, gas, LPG, petrol, diesel, water and chemicals from location to location.

It is common for such vehicles to transport flammable fluids such as liquid fuel; which means it is important for the payloads to not contaminate each other. This is achieved by limiting the liquids carried, so that a tank typically only carries one type of payload eg. water truck, petrol truck, gas truck.

However, during loading and unloading, the payload can be spilled on the exterior of the vehicle. Thus it is important for the exterior of the tank to be cleaned after each journey.

It would be advantageous to be able to drive the rig truck cab with tank attached through a car wash, but these are commonly too small. For the truck washes that are available, they are designed for box shaped rigs having a flat top, and do not cater for the round shape on the tank. This necessitates a rewash by hand.

Often washing the truck by hand is found to be the most efficient and cost effective method of cleaning the tanks. Typically it takes a couple of hours and involves having a brush on a handle and reaching upwards to scrub the tank to remove road debris and dust.

This method results in streaks and inaccessible spots. Cleaning can involve using a scaffold, ladder or similar to climb up to reach the top of the tank with a brush or hose. This can be dangerous, as the tanks are typically above 3 metres high and when on a ladder, applying force while hosing with water and soap suds, can result in a fall.

Similarly storage tanks for water, gas, fuel and other liquids fixed to the ground at their base can be difficult to clean with standard brushes currently available.

Thus it is an object of the invention to provide an apparatus for cleaning a rounded tank, or a method of cleaning a rounded tank for overcoming any of the abovementioned problems or at least an apparatus that provides the consumer with a useful commercial alternative to those apparatus for cleaning rounded tanks that already known in the prior art.

### SUMMARY OF THE INVENTION

According to a first aspect of the present invention there is provided an apparatus for cleaning a rounded tank, comprising:

a head having a base and scouring surface, the base of said head being attachable to a handle wherein the head is formed to have curved face adapted to fit the shape of a tank.

Preferably the curve of the head has a radius along its length.

Preferably the scouring surface comprises bristles in the form of a brush for dislodging debris from the tank.

Alternatively said scouring surface comprises a scouring pad.

Preferably the head is detachable, so that the head can be replaced as the scouring surfaces wears out or tears.

Preferably the handle is telescoping such that the length can be adjusted to suit the height of the tank targeted.

Preferably the handle includes a water conduit such that water can be pumped to the brush.

Alternatively the handle includes a water tank and trigger, such that water can squirted from the brush.

Alternatively the handle includes a bracket for a hose so that water can be applied after scrubbing.

There is also a provided method for cleaning a rounded tank comprising the steps of:
i providing an apparatus as described above;
ii inserting a head of the apparatus onto a handle;
iii scrubbing the rounded tank with the curve of the scouring surface corresponding to the curve of the tank; and
iv washing the tank with the aid of the apparatus by applying water to areas of the tank so scrubbed.

### BRIEF DESCRIPTION OF THE DRAWINGS

The Detailed Description is not to be regarded as limiting the scope of the preceding Summary of the Invention in any way. The Detailed Description will make reference to a number of drawings as follows:

FIG. 1 shows a side view of a first embodiment of the invention.

FIG. 2 shows a side view of a second embodiment of the invention with the telescoping handle extended.

FIG. 3 shows an isometric view of the invention from behind.

FIG. 4 shows an isometric view of the invention from the front.

FIG. 5 is an exploded view of an apparatus for cleaning a rounded tank according to a preferred embodiment of the invention.

FIG. 6 is an assembled view of the apparatus of FIG. 5.

FIG. 7 is a top plan view of the apparatus of FIG. 6 with the handle pivoted parallel to the base.

FIG. 8 is a front view of the apparatus of FIG. 6 with the handle pivoted at right angles to the base.

FIG. 9 is a side view of the apparatus of FIG. 6 in use against the side of a rounded tank.

FIG. 10 is a diagram of a further embodiment of the invention wherein the handle has mounted to it a water tank and trigger operated pump, such that water can be squirted from the brush.

FIG. 11 is a flowchart of a method of washing a tank according to a further embodiment of the present invention.

FIG. 12 shows a number of heads of the apparatus each having a different radius of curvature.

Preferred features, embodiments and variations of the invention may be discerned from the following Detailed Description which provides sufficient information for those skilled in the art to perform the invention.

### DETAILED DESCRIPTION OF PREFERRED EMBODIMENTS

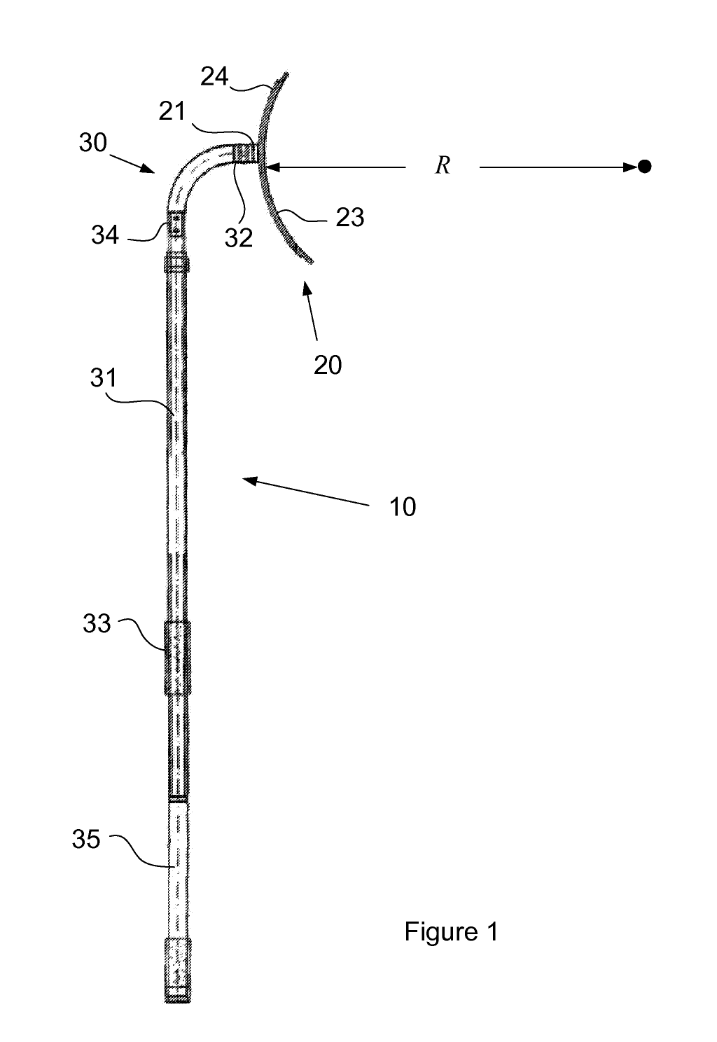

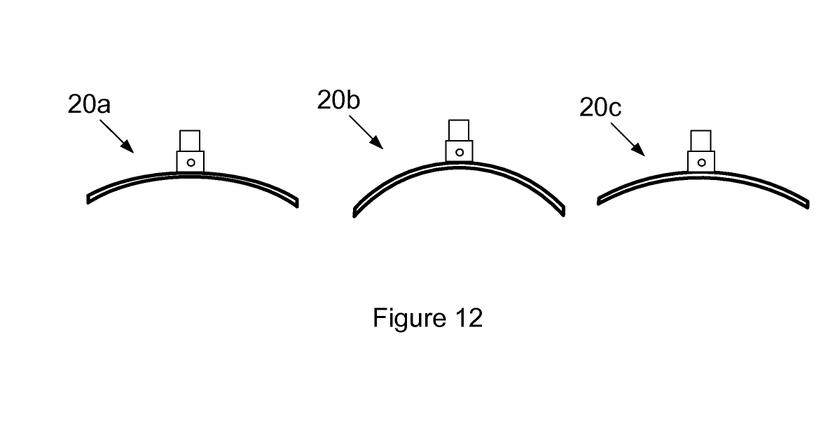

FIGS. 1 to 4 depict an apparatus 10 for cleaning a rounded tank according to a first embodiment of the present invention. The radius of curvature of the tank is standard across the cross section allowing for the profile to be reproduced on a cleaning head 20. The radius of curvature “R” is indicated in the profile of the head 20, as shown in FIG. 1. As shown in FIG. 12, heads of different radius of curvature 20a-20c may also be provided to suit differently curved tanks or differently curved portions of a tank to be cleaned. In other embodiments of the invention, adapted for use upon a tank having a corrugated surface, the head may include a corresponding corrugated cross section.

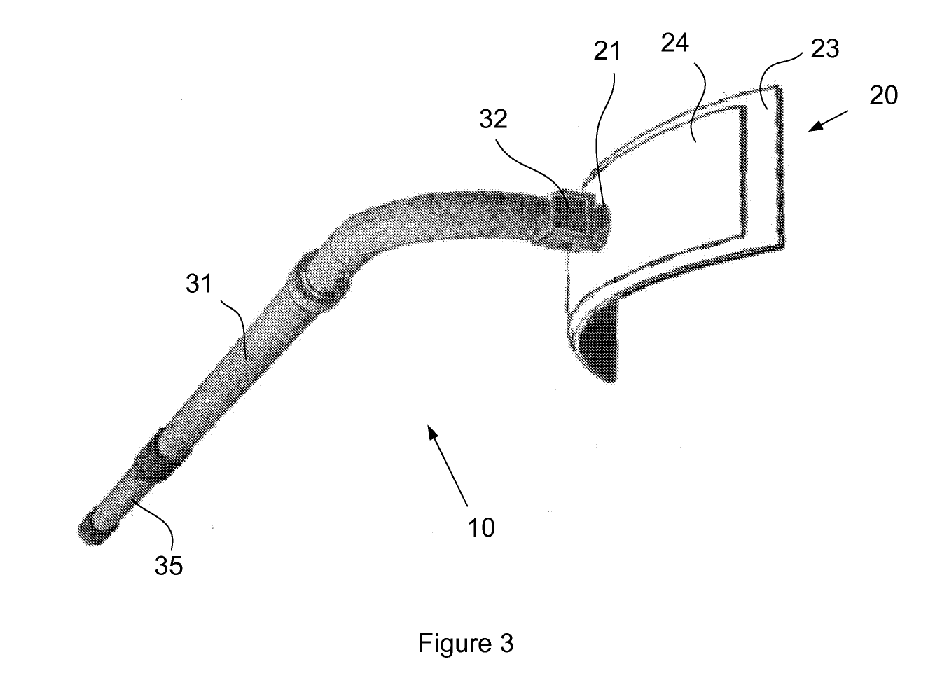

The head 20 includes a base 24 best shown in FIG. 3, which includes an attachment means 21 in the form of a socket allowing it to be attached to a handle 30.

The head 20 is generally rectangular with a concave curved profile along its longitudinal axis. The radius of curvature corresponds to the curvature of a tank such as the tank of a tanker truck such as a gasoline truck. For example, the radius of curvature may be about four feet in length for washing the tank of such a truck. The head 20 includes a face 23 disposed opposite to the base 24.

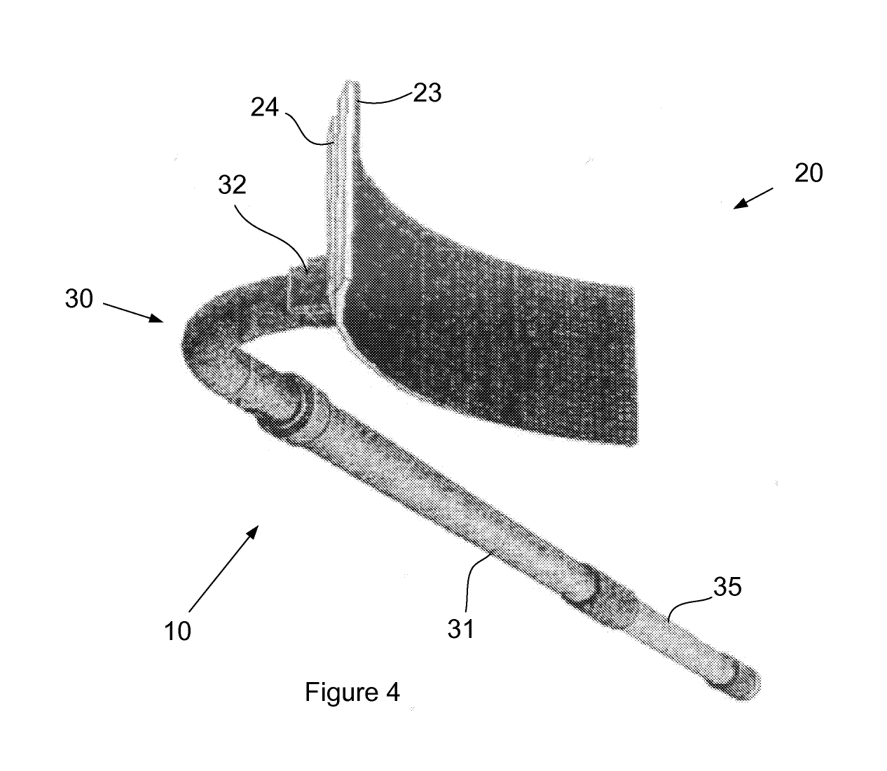

The face 23 includes a scouring surface such as bristles or other scouring material to remove debris from the surface of the tank. The scouring surface is best shown in FIG. 4. The scouring surface comprises either a disposable surface or the head is disposable, as would be understood by a person skilled in the art.

The head 20 is attachable to a handle 30. The handle includes an attachment formation 32, for example a plug that is received into socket 21, a swivel 34, a telescoping assembly 33 and two or more shafts 31, 35.

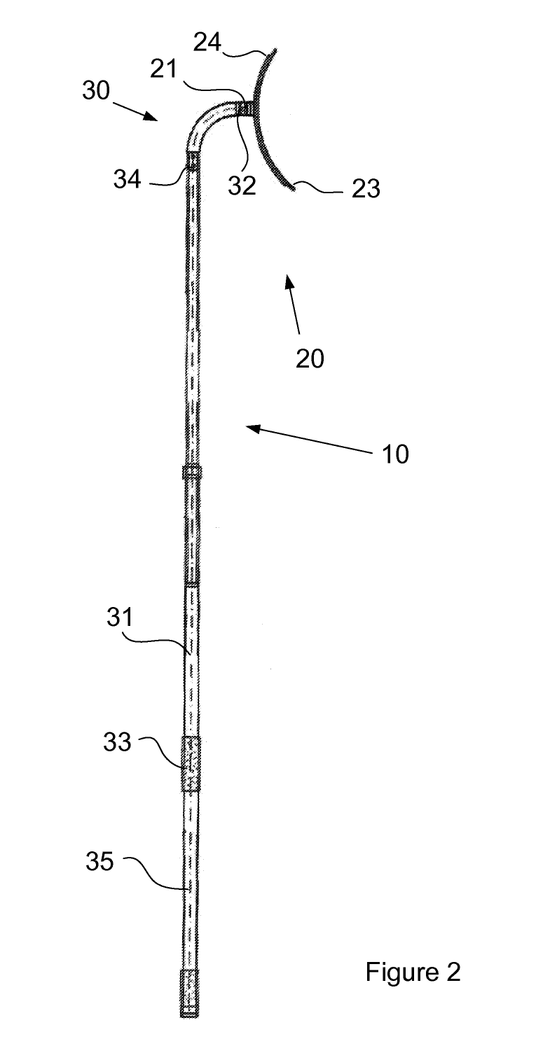

As can be seen in FIG. 1, a first shaft 31 is adapted to contain a second shaft 35 in a collapsed configuration and the telescoping assembly 33 allows the second shaft 35 to assume an extended configuration, as seen in FIG. 2.

The telescoping assembly consists of a nestable arrangement with a lock allowing movement between the collapsed configuration and the extended configuration.

The attachment means 32 comprises a screw and thread though a, fit lock, bolt, pin lock or other suitable clasping mechanism for attaching the head and the handle, as would be understood by a person skilled in the art might also be used.

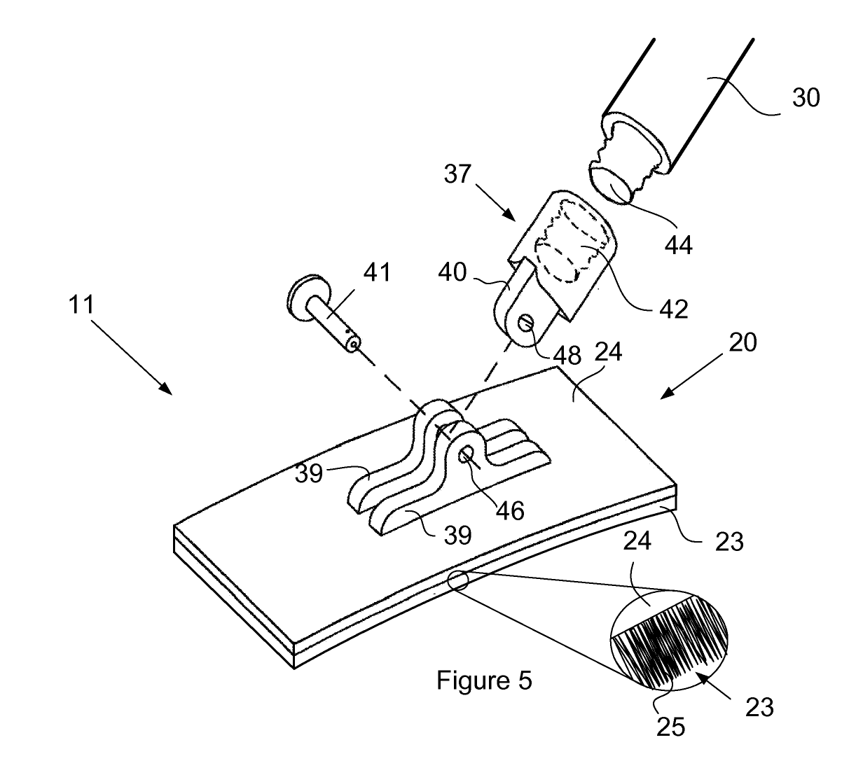

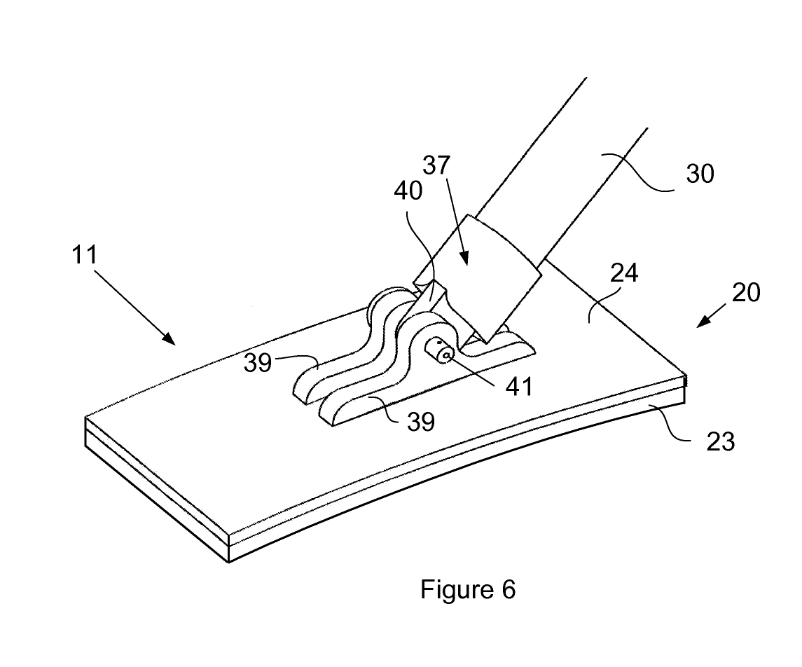

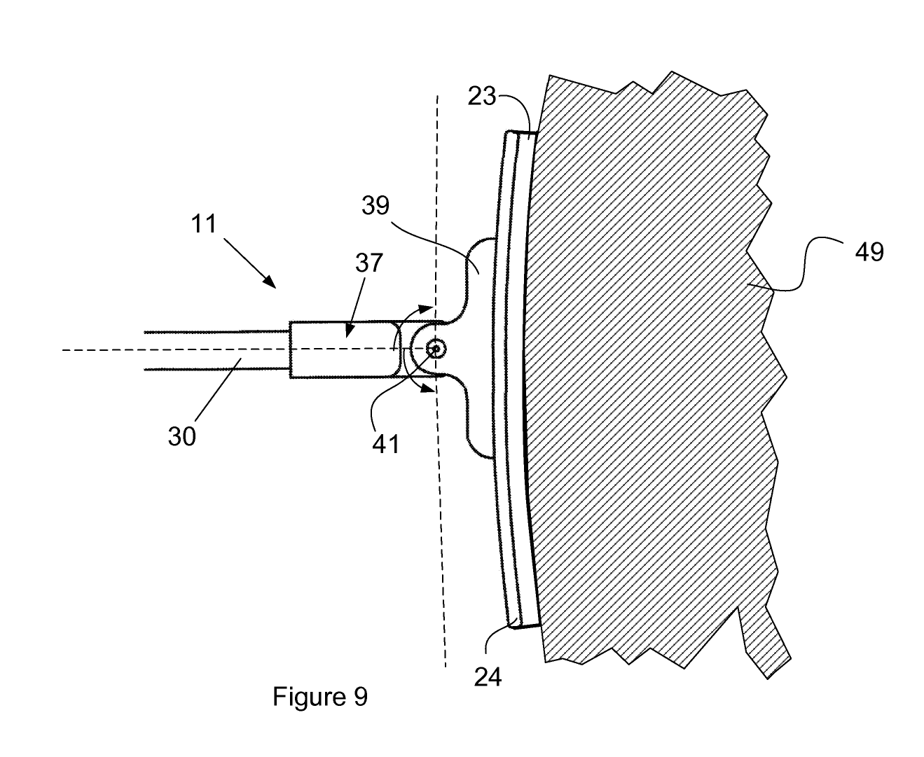

An apparatus for cleaning a rounded tank 11, according to a further and preferred embodiment of the invention is depicted in FIGS. 5 to 9. A pivoting coupler 37 is provided between the handle 30 and the base 24 of the head 20. In this embodiment the base 24 of the head 20 is formed with lugs 39 which receive a tongue 40 therebetween formed on an end of the pivoting coupler 37. A pin 41 traverses corresponding holes in the lugs (lug holes 46) and pivoting coupler (pivoting coupler tongue hole 48) in order to allow the pivoting coupler to pivot relative to the head 20. An exploded view of the interconnection of the base and the pivoting coupler is shown in FIG. 5. FIG. 6 shows the assembled apparatus 11. The close up detail of FIG. 6 shows bristles 25 of the scouring face 23.

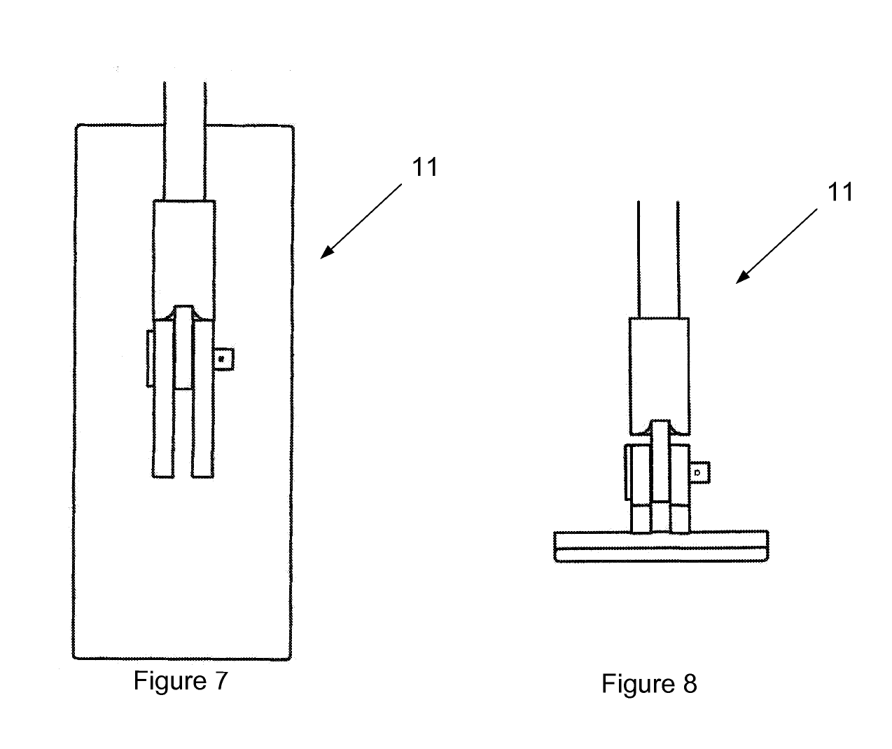

Further views of the base of the head 20 of this second embodiment are depicted in FIGS. 7 to 9. Referring again to FIG. 5 it will be observed that the pivoting coupler 37 is formed with a threaded socket 42 for receiving a similarly threaded plug 44 of the handle 30. Accordingly, the handle 30 may be screwed and unscrewed on and off the pivoting coupler 37.

FIG. 9 is a side view of the apparatus for cleaning rounded tanks 11 in use. It will be observed that the curved lugs 39 space the pivot 41 a sufficient distance from the pivoting coupler to allow it to swing through over 180 degrees, as indicated by the dashed lines which represent the long axis of the handle 30, so that the handle 30 can align parallel with the head 20. Consequently a user can apply the cleaning head 20 to the tank over a wide range of angles.

Other benefits of an apparatus for cleaning rounded tanks according to the preferred embodiment of the invention are as follows:

The filleted lugs 39, minimize stress points and disperse load forces evenly, to reduce possible fracture and shear stresses thereby imparting longevity.

The pivoting coupler 37, has 2 flat sides e.g. the sides of tongue 40 that fit between the upright lugs 39 on the base 21 of the head 20. The flat surfaces of the tongue have a greater contact area, thus giving stability and strength, where the round rod end has a threaded end socket for various telescopic rod handles.

The head 20 incorporates a curvature, which hugs a round/oval cleaning surfaces such as a rounded tank thereby having a greater contact cleaning surface than if it were flat. The broom head 20 is also flexible to take up the applying pressure/load required for its normal operation.

The pivoting coupler 37 has two flat sides that fit between the upright i.e. lugs 39 on the head 20. The flat surfaces of the tongue 40 of the pivoting coupler are received between the lugs 39, thus giving stability and strength over a range of angles between the handle and the head. The round rod end of the pivoting coupler has a threaded socket 42 to receive interchangeable telescopic rod handles of different lengths to suit the cleaning situation as desired.

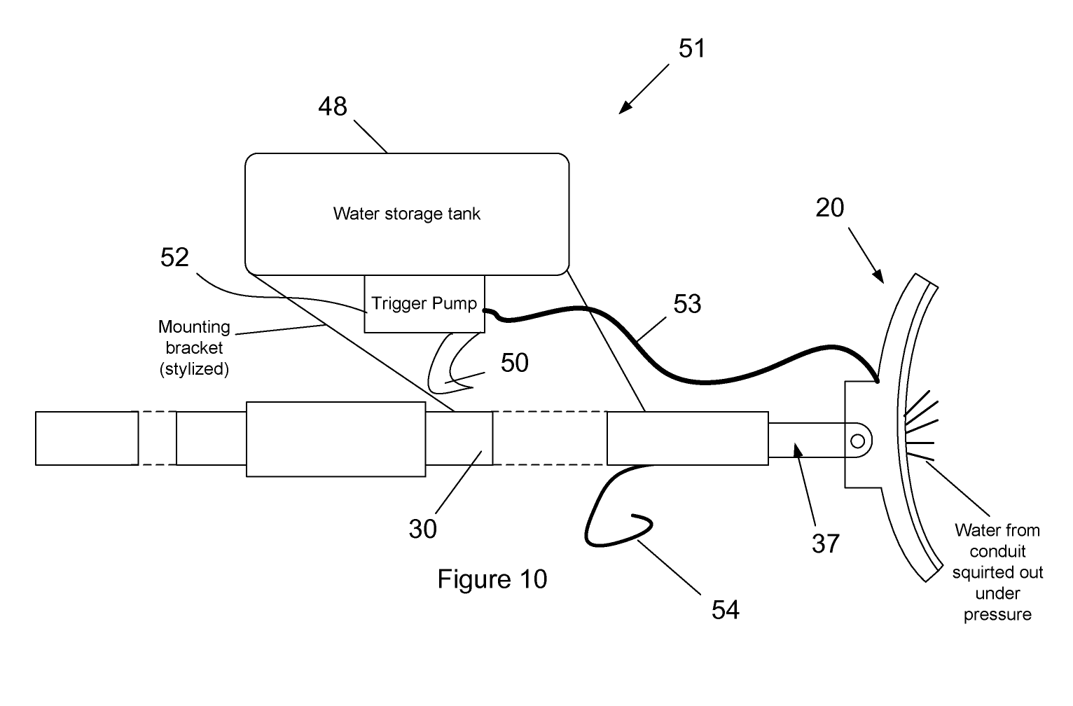

Referring now to FIG. 10, a diagram is provided of an apparatus for cleaning a rounded tank 51 according to a further embodiment of the invention wherein the handle has mounted to it a water tank 48 and trigger 50 coupled to a trigger operated pump 52, such that water can be squirted via a conduit 53 from the pump and out through the brush under pressure.

A bracket 54 for a hose may also be incorporated as shown so that water can be applied from the hose after scrubbing.

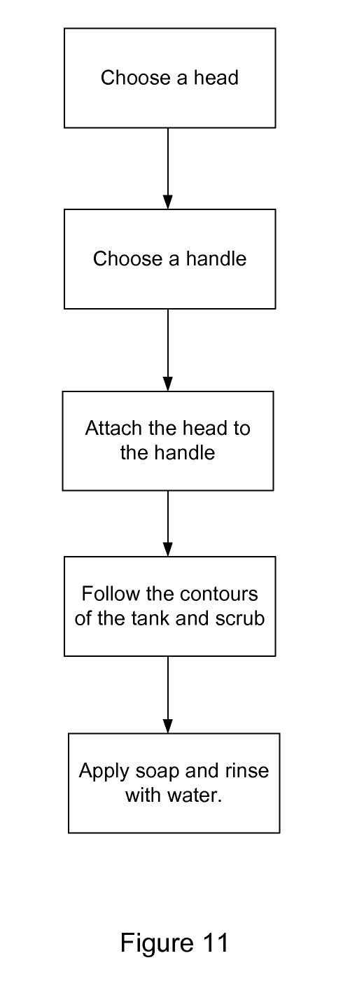

With reference to FIG. 11, there is set out a flowchart of a method for cleaning a rounded tank comprising the steps of:

Providing a range of cleaning heads, e.g. as illustrated in FIG. 12. Selecting a head with a curvature to suit a tank or a portion of a tank to be cleaned. Selecting a handle, e.g. a handle of suitable length for the tank may be selected. Attaching the head to the handle, for example by screwing it to the pivoting coupler of the head. Holding the handle to thereby apply the head to the contours of the tank to be scrubbed and applying soap and rinsing with water during the scrubbing.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

I claim:

1. An apparatus for cleaning a rounded tank, comprising:
a head having a base and scouring surface, the base of said head being attachable to a handle
wherein the head is formed with a curved face adapted to fit the shape of a tank.

2. An apparatus according to claim 1, wherein the scouring surface comprises bristles in the form of a brush for dislodging debris from the tank.

3. An apparatus according to claim 1, wherein said scouring surface comprises a scouring pad.

4. An apparatus according to claim 1, wherein the head is detachable, so that the head can be replaced as the scouring surface wears out or tears.

5. An apparatus according to claim 1, wherein the handle is telescopic.

6. An apparatus according to claim 1 including a water conduit coupled to the head water whereby water can be urged out from the head.

7. An apparatus according to claim 6, including a water tank and pump coupled to the conduit whereby water can be pumped from the tank into the conduit.

8. An apparatus according to claim 1 including a bracket arranged to retain a water hose for application of water after scrubbing.

9. A method for cleaning a rounded tank with an apparatus according to claim 1, the method comprising the steps of:
providing an apparatus according to claim 1;
coupling the head of the apparatus onto the handle;
scrubbing the rounded tank with the curved face of the scouring surface corresponding to the curve of the tank; and
washing the tank by applying water to areas so scrubbed.
